(19) United States
(12) Patent Application Publication
(10) Pub. No.: US 2022/0134295 A1
(43) Pub. Date: May 5, 2022

(54) METHOD AND DEVICE FOR OPTIMIZING THE OPERATING STATE OF SHAKING MACHINES

(71) Applicant: AQUILA BIOLABS GMBH, Baesweiler (DE)

(72) Inventors: Konrad Herzog, Herzogenrath (DE); David Frank, Herzogenrath (DE)

(21) Appl. No.: 17/429,606

(22) PCT Filed: Jan. 29, 2020
(86) PCT No.: PCT/EP2020/052118

§ 371 Date: Aug. 9, 2021

(30) Foreign Application Priority Data
Feb. 8, 2019 (DE) 10 2019 000 933.9

(51) Int. Cl. B01F 35/22; G05B 13/04; B01F 31/22

(52) U.S. Cl. CPC B01F 35/2209; B01F 2101/23; B01F 31/22; G05B 13/042

(57) ABSTRACT

A method for operating a shaking machine, in particular for optimizing an operating state of the shaking machine, including shaking at least one shaking material in at least one shaking vessel; setting at least one target operating parameter to at least one target value or one target range; detecting an adjustment range of at least one additional operating parameter; determining an operating state by means of an optimizer that varies at least one adjustable operating parameter and by using at least one model, such that at least one target operating parameter maintains, achieves, or approaches the target value or target range, wherein at least one operating state of the shaking machine is imaged by at least one model.

### CROSS REFERENCE TO RELATED APPLICATIONS

This is a US national phase application under 35 U.S.C. § 371 of international application no. PCT/EP2020/052118, filed 29 Jan. 2020, which claims benefit of priority to German patent application no. 102019000933.9, filed 8 Feb. 2019; the entire content of each is herein incorporated by reference in its entirety

### TECHNICAL FIELD

The invention relates to a device and method for optimizing the operating state of shaking machines using a model having an adjustable operating parameter to adjust conditions to meet at least one target parameter.

### BACKGROUND OF THE INVENTION

Shaking machines are devices which are used in particular to mix shaking materials in suitable vessels. Shaking machines usually comprise a shaking drive which moves a shaking platform on which at least one shaking material is located in at least one vessel, which is mixed by the shaking movement. A wide variety of shaking movements are used, which differ particularly in terms of their type (e.g. orbital shaking, rocking shaking), their speed, deflection, regularity etc.

Depending on the shaking movement and loading of the shaking platform, unstable operating states occur during the shaking operation, which either adversely affect the quality of the shaking movement or results in disadvantageous wear of the shaking machine, in particular, but not exclusively, due to eccentric weights, unbalances, centrifugal forces, and vibrations. To avoid this, either constructive countermeasures must be taken or the operating state of the shaking machine must be optimized.

### PRIOR ART

Various methods and devices are known to a person skilled in the art for constructively limiting unstable operating states of shaking machines. For example, EP2301679A2 and DE102006021851A1 disclose shaking devices having fixed balancing masses, which limit the occurrence of unstable operating states of shaking machines by an expedient arrangement on different lever arms, by positioning below and/or above the shaking platform, and by suitable lever arm lengths, mounting, balancing mass ratios, phase shift, and arrangement of the balancing weights.

A disadvantage with regard to such devices is that the dimensioning and arrangement of the balancing weights only takes place at the time of manufacture of the shaking machine, such that, in principle, later adjustments are no longer possible. This is particularly disadvantageous since shaking platforms are loaded differently depending on the application. The resulting mass distributions and torques can therefore disadvantageously not be fully compensated. In order to nevertheless allow for at least sufficiently stable operating states, the balancing weights must be designed so high that the influence of the load-related mass and torque distribution on the operating state of the shaking machine remains small. This results in disadvantageously large and heavy constructions which block valuable work surfaces, are difficult to transport, and have a high energy requirement for setting and maintaining the desired shaking operating state. Another disadvantage is that this device cannot be used to make any changes to the shaking stroke during operation, since the associated changes in force and torque can no longer be adequately compensated for by the balancing weights without repositioning them.

DE102014111236B3 discloses an orbital shaker having a balancing device that automatically and passively compensates for unbalance-related forces and torques that arise during operation due to variable loading (mass, geometry of the vessels, properties of the ingredients) and variable operating parameters (speed and shaking radius). This is achieved by freely moving, guided balancing weights, which align themselves during the shaking operation according to the forces and torques that act accordingly thereupon, such that unbalance-free shaking is possible.

However, this can only be implemented with the disadvantage of large and heavy constructions which block valuable work surfaces, are difficult to transport, and which, due to the balancing weights and guides that have to be moved, have a high energy requirement to set and maintain the desired shaking operating state. The energy stored in the movement of the balancing weights can only be transmitted through friction, which must be low for the purpose of automatic balancing (in particular as rolling or sliding friction). However, this disadvantageously hinders rapid acceleration and deceleration processes since the energy stored in the balancing weights can only be built up or reduced slowly. In particular, therefore, for high shaking speeds, as are often necessary for optimal mixing and aeration of shaken cultures, long acceleration and deceleration times are disadvantageous for the user. If, on the other hand, these are designed too short, the energy and torques stored in the freely movable balancing weights can disadvantageously result in dangerous vibrations and shocks, which in turn represent a disadvantageously unstable operating state, which has a negative impact on stability, in particular in the case of a plurality of stacked shaking machines of their respective operating state.

U.S. Ser. No. 020180111102A1 and U.S. Pat. No. 8,226,291B2 disclose orbital shakers with adjustable balancing weights, as well as methods for their operation. They describe actively adjustable balancing weights that compensate for unbalances by actively adjusting the angle between the balancing weights. Methods are also disclosed for setting stable operating states using the disclosed orbital shaker. For this purpose, a vibration parameter is detected during the shaking operation and, if a critical limit value is exceeded, the shaking drive is slowed down, stopped, or the angle between the counterweights is automatically adjusted.

The disadvantage in this case is only an adjustment of the unbalance forces and not the unbalance torques. Another disadvantage is that unstable operating states are only recognized during shaking, at the moment they occur, and can thus already have a negative effect on the shaking machine or the shaking material. The detection of a vibration parameter as a goal of operating state optimization is also disadvantageous, since this is only a symptom of unstable operating states, but cannot explain them. As a result, the disclosed shaking device has to perform a real scan of the operating parameters (in this case, shaking speed and angle between the balancing weights), which is disadvantageously time-consuming and does not necessarily converge, such that the method disclosed alone does not always allow the user to successfully set the shaking speed desired by the user for a given load. Finding stable operating states according to the disclosed method is made even more difficult in the case of stacked shaking machines. No parallel scans can be carried out there since each shaking machine involved can cause a vibration. This can only be ruled out through sequential scans, such that the successful finding of a stable operating state as desired by the user becomes even more tedious and unlikely, in particular since sequential scans cannot evaluate and describe the complex behavior of a plurality of parallel operated and mechanically coupled shaking machines. In order to still be able to achieve sufficiently stable operating states in the majority of all applications, large counterweights are used, which use results in disadvantageously large and heavy shaking machine constructions which block valuable work surfaces, are difficult to transport, and have a high energy requirement for setting and maintaining the desired shaking operating state.

EP 2 714 253 B1 discloses an orbital shaker. A user can enter parameters using a control unit with a user interface. Control loops are used to produce a desired operating state.

WO 2018/184 959 A1 discloses a mixing device which is used in particular for the provision of liquid color. In this case, the mixing device is operated according to a preset program. The drive torque is monitored while the program is running and the program can be modified depending on the drive torque determined.

DE 10 2012 002 891 A1 discloses a laboratory device which can be a shaking device. The laboratory device is monitored during operation to determine whether it is in a state that is not intended for operational use and/or is potentially dangerous. Such a state is determined on the basis of a detection of a movement of the laboratory device. As a reaction to this state, the laboratory device can be switched off automatically within the meaning of a safety-relevant reaction.

DE 10 2004 018 882 A1 discloses a combine harvester having a straw walker. This can be used to process different types of grain, each with different crop properties. The processing of the crop on the straw walker is set based on properties of the crop.

Thus, there are no known methods and devices that are suitable for safely and quickly minimizing or eliminating the adverse effects of unbalances during the shaking operation, which result from the combination of all operating parameters, and thus ensuring a stable operating state without, at the same time, requiring massive and expansive constructions.

### Object

It is therefore the object of the present invention to provide a method by means of which the operating state of shaking machines can be optimized in such a way that adverse effects of unbalances during the shaking operation are efficiently eliminated, while at the same time reducing the structural requirements with regard to mass and spatial expansion of the shaking machine using the method compared to the current prior art.

### BRIEF SUMMARY OF THE INVENTION

According to the invention, the problem is solved by a method for optimizing the operating state of shaking machines, which is based on the basic idea that the operating states of shaking machines can be modeled on the basis of the parameters influencing these operating states. With knowledge of these parameters and a suitable model, it is thus possible to determine, estimate, or predict the operating states of shaking machines, in particular, but not exclusively, without having the shaking machine in operation or in an operating state that does not correspond to the desired operating state. In this respect, by modeling and optimizing operating states by adjusting the operating parameters, an optimal operating state can be determined and achieved during the operation.

The object is achieved according to the invention in particular by a method for optimizing the operating state of shaking machines, wherein at least one shaking material is to be subjected to a shaking movement in at least one shaking vessel, and wherein at least one target operating parameter is set to at least one target value or one target range. The method according to the invention for solving the problem is characterized in that the adjustment range of at least one additional operating parameter is detected and in that at least one operating state of the shaking machine is imaged with at least one model, which comprises at least one adjustable operating parameter and at least one target parameter, and in that, by means of an optimizer, by variation of at least one adjustable operating parameter and using at least one model, an optimal operating state is determined, such that at least one target operating parameter can maintain, achieve, or approach the target value or target range thereof.

According to the invention, the operating state of a shaking machine is defined by a large number of parameters, the influence of which on the operating state can be mathematically modeled. For carrying out a shaking process, according to the invention, at least one target operating parameter (for example the shaking speed or the filling volume of a vessel) is defined, whereas other operating parameters are not defined. This results in an optimization margin, such that an optimal operating state can be calculated by adjusting the operating parameters that have not been specified, from which in turn the optimal operating parameters necessary for setting the operating state during the shaking operation are derived. According to the invention, at least one operating parameter must not be specified, since otherwise no optimization is possible.

According to the invention, the operating state is optimized by means of suitable search and optimization algorithms which, in particular, but not exclusively, can be integrated into the software of the control computer of the shaking machine.

According to the invention, the optimization is adjustable with regard to possible weights and tolerances for achieving the target values or target ranges of target operating parameters. In some embodiments of the invention, these adjustments are made automatically and in other embodiments are defined by a user. Such tolerances can be used according to the invention in order to simplify the finding of an optimal operating state or even to allow it in the first place.

According to the invention, the result of the optimization can also be the determination of the inaccessibility of an optimal operating state under the given target operating parameters, tolerances, and adjustable target operating parameters. In an advantageous embodiment of the invention, the optimizer transmits this inaccessibility of an optimal operating state to the user and submits suitable suggestions for adjusting target operating parameters or tolerances in order to be able to achieve an optimal operating state of the shaking machine that is as close as possible to the user requirements.

According to the invention, at least one target operating parameter is set to a target value or target range either by the user (for example as a specification of the shaking speed) or by suitable sensors or computers according to the invention.

According to the invention, the adjustment range of at least one further operating parameter is detected either by the user (for example as a specification of the shaking speed range) or by suitable sensors according to the invention.

In an advantageous embodiment of the invention, regardless of possible user inputs, as many operating parameters as possible are detected in order to place the model according to the invention on the broadest possible database. Operating parameters relating to the stability of the shaking movement and the avoidance of unbalances during the shaking operation are of particular importance.

In an advantageous embodiment of the invention, the shaking platform including all devices, vessels, shaking materials, and other bodies that are shaken therewith is therefore imaged by the model according to the invention. For this purpose, using suitable sensors, in particular, but not exclusively, data is detected on the type, geometry, and position of the shaking vessels, the mass, distribution, and fluid-dynamic behavior of the shaking materials contained therein, the shaking frequency, the shaking stroke, and the position and dynamic behavior of balancing weights.

Furthermore, in an advantageous embodiment of the invention, suitable sensors are used to collect data for describing the inertial systems of the shaking machine and all shaken or otherwise moving parts on top of, on, or in the shaking platform, the shaking machine, or the shaking drive, in particular, but not exclusively, accelerations, rotation rates, and orientation and position data.

According to the invention, fill levels, distributions, or fluid dynamic behavior of the shaking material and the positioning of the shaking vessels on the shaking platform are detected by suitable resistive, capacitive, inductive, or optical sensors or by one or more cameras.

In some embodiments of the invention, the data for positioning the shaking vessels are also used to select or control online analytical sensors which monitor processes in the shaking material in their respective effective range. In particular, such sensors can be switched on or off depending on the presence of shaking material in their effective range.

In some embodiments of the invention, the data from a plurality of sensors are merged or preprocessed before being fed into a model according to the invention or an optimizer according to the invention, for example also within the context of soft sensors or within the context of the combination of the data from a plurality of cameras in three-dimensional models of the shaking materials, shaking vessels, and shaking platform as well their distribution and movement during the shaking operation.

Sensors according to the invention can be integrated into the shaking platform, located inside the shaking machine, or they can be outside the shaking machine.

In an advantageous embodiment of the invention, the method according to the invention is used both for planning the optimal operating state before the start of the shaking operation and for monitoring the maintenance of the optimal operating state and for planning changes to the optimal operating state.

In some embodiments of the invention, using the method according to the invention, adjustments of operating parameters are carried out during ongoing shaking operation in order to maintain the optimal operating state. Thus, according to the invention, detected changes in mass and volume of the shaking materials can be automatically compensated for by evaporation, sampling, or feeding, in particular, but not exclusively, by automatic adjustments in the balancing device.

In some embodiments of the invention, loading recommendations resulting from the search according to the invention for an optimal operating state, in particular with regard to the positioning of shaking vessels and shaking materials on the shaking platform, are represented by suitable visualization methods and devices, for example by means of lighting devices such as LEDs integrated into the shaking platform.

In an advantageous embodiment of the invention, the sensors that are integrated into the shaking platform are designed, in particular, as scales, resistive, capacitive, inductive, or optical sensors, as arrays of many small sensors, in order to achieve a high position resolution when detecting the load characteristics as important operating parameters.

In an advantageous embodiment of the invention, the balancing device is also adjustable as a function of position, for example by designing sub-devices arranged in the manner of an array, in order to be adjustable to the position-dependent loading of the shaking platform. In some embodiments of the invention, this is implemented by a large number of small balancing weights moved by servomotors, which are advantageously adjustable in all three spatial directions in order to be able to adjust the centers of gravity, forces, and unbalance torques as part of the inventive optimization of the operating state.

In an advantageous embodiment of the invention, the position-dependent adjustability of the balancing device allows a local balancing of the loaded shaking platform as a shaken unit, tailored to the positioning, mass, shape, and distribution of the shaking materials and shaking vessels, such that only small and relatively light balancing weights of the order of magnitude of the loading weights are necessary and that these balancing weights compensate locally for the unbalance forces and torques of the loading of the shaking platform by suitable positioning.

In an advantageous embodiment of the invention, the positions and masses of the local sub-devices of the balancing device are part of the model according to the invention and can thus be adjusted as adjustable operating parameters by means of the optimizer according to the invention.

In some embodiments of the invention, the balancing device consists of many small, array-like arranged sub-balancing devices, which can in particular be fluid-based. In this case, each sub-balancing device comprises a cavity of the order of magnitude of the volume of shaking materials usually used, this cavity being adjustable to be filled or emptied with liquid and thus with balancing weight. Overall, such an array-like balancing device can thus locally compensate for the unbalances that result from the loading with liquid shaking materials and locally influence the mass and the behavior of the shaking platform during the shaking operation.

In some embodiments of the invention, the balancing device is adjusted by local absorption or delivery of balancing weights, in particular as liquids or as solids, which can be gripped by the balancing device or picked up or deposited by means of magnetic forces.

In some embodiments of the invention, the balancing weights of the adjustable balancing device can also be positioned in or above the plane of the shaking materials or shaking vessels in order to carry out local balancing and thus to keep the total mass and size of the balancing device low.

In an advantageous embodiment of the invention for stacked shaking machines, these are imaged together by a model in order to be able to determine an optimal operating state for each shaking machine without interference with the other shaking machines of the stack.

The present invention will be explained in more detail with reference to the figures and embodiments. Reference signs in the figures which designate components of the invention that were used already in the same figure or in another figure under the same circumstances or in the same representation are partially omitted in order to maintain the clarity of the figures. Graphic elements without reference signs are therefore to be interpreted in consideration of the list of reference signs, the other figures, the designated representations within the same figure, the patterning or structuring of already designated graphic elements and with reference to the entire description and the claims.

### BRIEF DESCRIPTION OF THE DRAWINGS

FIG. 1 is a schematic view of the relationships between the components of the method according to the invention.

FIG. 2 is a schematic block diagram of the method according to the invention.

FIG. 3 is a schematic view of an embodiment of the method according to the invention.

FIG. 4 is a schematic view of a device according to the invention for carrying out the method according to the invention.

### DETAILED DESCRIPTION

To ensure the clarity of some terms used in the description, they are defined and explained below and throughout the description.

A shaking machine within the meaning of the invention is any device or combination of devices that is suitable for subjecting shaking materials and shaking vessels to a shaking movement. The shaking machine is in particular an orbital shaker.

A shaking material within the meaning of the invention is any form of matter or material mixture which is to be shaken to achieve a determined process goal. Shaking materials within the meaning of the invention are in particular, but not exclusively, culture broths, mixtures of culture medium and cells, liquids, solutions, emulsions, dispersions, slurries, suspensions, foams, gas mixtures, or powder mixtures.

A shaking vessel within the meaning of the invention is any device and vessel that is suitable for receiving or storing shaking materials. It can be open or closed. Shaking vessels within the meaning of the invention are, in particular, but not exclusively, shaking flasks, reaction tubes, falcons, T-flasks, microtiter plates, shaking bags and shaking barrels of any geometry, material composition, and filling quantity.

Shaking movements within the meaning of the invention are movements which are suitable for moving or mixing the shaking materials contained in them by moving the shaking vessels. Shaking movements within the meaning of the invention are in particular, but not exclusively, orbital shaking, rocking shaking, and tumbling shaking. Shaking movements within the meaning of the invention can be carried out continuously or discontinuously, depending on the process requirements.

According to the invention, each shaking machine has an operating state at all times, which is defined and influenced by a large number of different parameters. Within the meaning of the invention, target operating parameters are those parameters that are set to a target value or target range, and further operating parameters are those parameters that have no target setting. All parameters according to the invention can be adjustable within the limits of tolerances or adjustment ranges. Parameters within the meaning of the invention that describe, define, or influence the operating state of shaking machines are in particular, but not exclusively, shaking speed and stroke, type of shaking, smooth running, vibrations, load distributions and positions, type, geometry, material, and mass of shaking vessels and shaking materials, as well as the distribution and the dynamic behavior of the latter during the shaking operation, furthermore the location, position, mass, viscosity, and distribution of balancing weights, the temperature, the air pressure, the humidity, the density of the air, etc.

Operating states of shaking machines can be stable or unstable, stable operating states being distinguished from unstable operating states by the fact that vibration, unbalance, and wear phenomena are reduced to a minimum and that they can be sustained for a long time without catastrophic failure of the shaking machine or one of the components thereof. Optimal operating states are stable operating states which, in addition, also achieve, maintain, or approach the target values or target ranges of all specified target operating parameters or within the framework of tolerances.

Models within the meaning of the invention are all such mathematical constructs that describe at least one operating state partially or completely using parameters that influence this operating state.

Sensors within the meaning of the invention are all those devices that are suitable for detecting parameters that influence at least one operating state. Sensors within the meaning of the invention are therefore, in particular, any type of resistive, capacitive, inductive, or optical sensors, cameras, sound sensors, scales, strain gauges, LIDAR, RADAR, SONAR, acceleration sensors, yaw rate sensors, orientation sensors, and position sensors and any type of soft sensors that are triggered by fusion or data processing of other sensors.

Optimizers within the meaning of the invention are all methods and algorithms that are suitable for optimizing an optimization target (for example the operating state with defined target operating parameters) by varying parameters that influence the optimization target. Optimizers within the meaning of the invention are in particular, but not exclusively, numerical search and optimization methods, heuristics, and all types of machine learning (e.g., neural networks, support vector machines, etc.). Optimizers are implemented in software and run on computers.

Computers within the meaning of the invention are all devices, in particular electronic devices, that can store data (in particular arithmetic and logical data) and process it based on programmable rules. In particular, but not exclusively, microcontrollers, microprocessors, system-on-a-chip computers (SoC), PCs and servers, as well as networks of computers, are considered to be computers within the meaning of the invention.

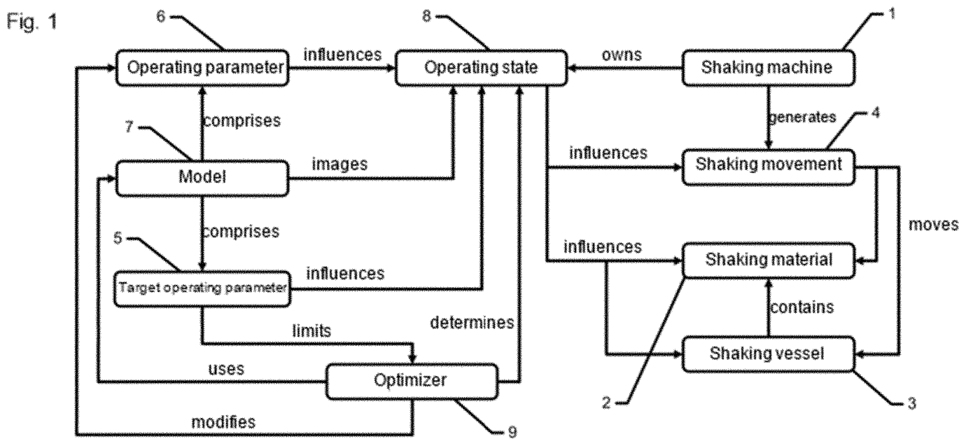

Turning now to the drawings, FIG. 1 is a schematic view of the relationships between the components of the method according to the invention. A shaking machine 1 generates a shaking movement 4 and thus moves at least one shaking vessel 3 and the shaking material 2 contained therein. At all times, the shaking machine 1 has an operating state 8 which, by influencing the shaking movement 4, also influences at least one shaking vessel 3 and the shaking material 2 contained therein. The operating state 8 is influenced by a large number of different parameters, the target operating parameters 5, in contrast to other operating parameters 6, being set in each case to a target value or target range, which are only adjustable within determined, mostly predefined tolerances. The operating state 8 is imaged by at least one model 7, which comprises at least one target operating parameter 5 and at least one further adjustable operating parameter 6. By imaging the operating state 8 by means of at least one model 7, the influence of the operating parameters 6 and target operating parameters 5 are mathematically evaluated with respect to the operating state. According to the invention, this is also done by at least one optimizer 9, which uses at least one model 7 to determine an optimal operating state 8 by modifying at least one adjustable operating parameter 6 and limiting or maintaining at least one target operating parameter 5 to the target value or target range thereof.

In some embodiments of the invention, various models 7 are used to image the operating state 8. In some embodiments of the invention, the use of suitable models 7 for imaging the operating state 8 is, in particular, but not exclusively, dependent on the type and value of the operating parameters 6 and target operating parameters 5 under consideration.

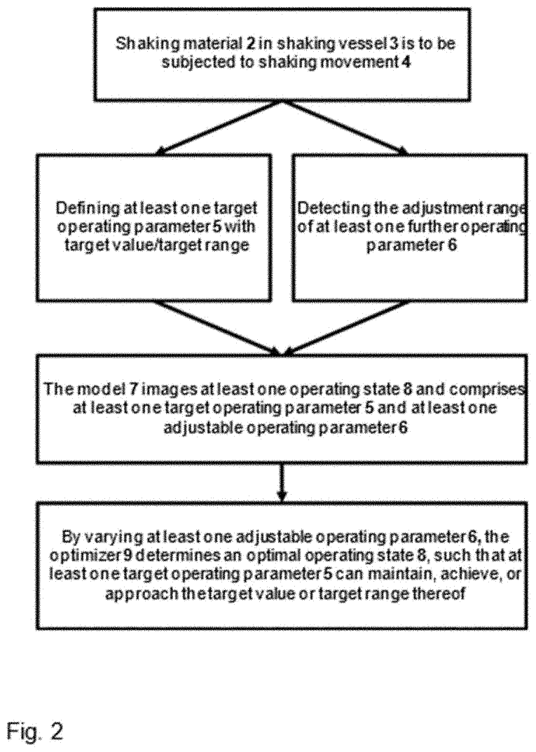

FIG. 2 is a schematic block diagram of the method according to the invention. According to the invention, at least one shaking material 2 is to be subjected to a shaking movement 4 in a shaking vessel 3. This state is given both before the start of a shaking operation and during the shaking operation when the shaking movement 4 is to be maintained or changed in the latter. According to the invention, at least one target operating parameter 5 is now set to a target value or target range. In an advantageous embodiment of the invention, a tolerance range is also defined by which the target operating parameter 5 may deviate from the target value in the desired shaking operation. Furthermore, the adjustment range of at least one further operating parameter 6 is detected, which can later be used by the optimizer 9 in order to determine the optimal operating state 8 of the shaking machine 1. The definition of target operating parameters 5 and the detection of the adjustment ranges of further operating parameters 6 can take place according to the invention in any order, once or repeatedly, sequentially or in parallel.

According to the invention, taking into account at least one target operating parameter 5 and at least one further, adjustable operating parameter 6, at least one model 7 is set up which is suitable for imaging the operating state 8. At least one such model 7 as well as at least one adjustable operating parameter 6 and at least one target operating parameter 5 are used by at least one optimizer 9 in order to determine an optimal operating state 8 of the shaking machine 1 by varying at least one operating parameter 6 in the adjustment range thereof, such that at least one target operating parameter 5 can maintain, achieve, or approach the target value or target range thereof.

In an advantageous embodiment of the invention, the optimizer 9 outputs, in the event of failure to achieve a target value or range, that operating state 8 as optimal operating state 8 which is closest to the predetermined target value or target range. In some embodiments of the invention, the optimizer 9 also outputs recommendations as to which target ranges or target values would have to be adjusted or given a higher tolerance in order to achieve an even better operating state 8.

In an advantageous embodiment of the invention, the operating parameters 6 and target operating parameters 5, which cause the optimal operating state 8 found by the optimizer 9, are set after the optimal operating state 8 has been found by a user or automatically by suitable devices or the shaking machine 1 or their components.

In an advantageous embodiment of the invention, the method according to the invention is also carried out repeatedly while the shaking operation is in progress in order to verify the maintenance of the optimal operating state 8 or to determine and set a new optimal operating state 8 in the event of process-related changes in operating parameters 6 or target operating parameters 5.

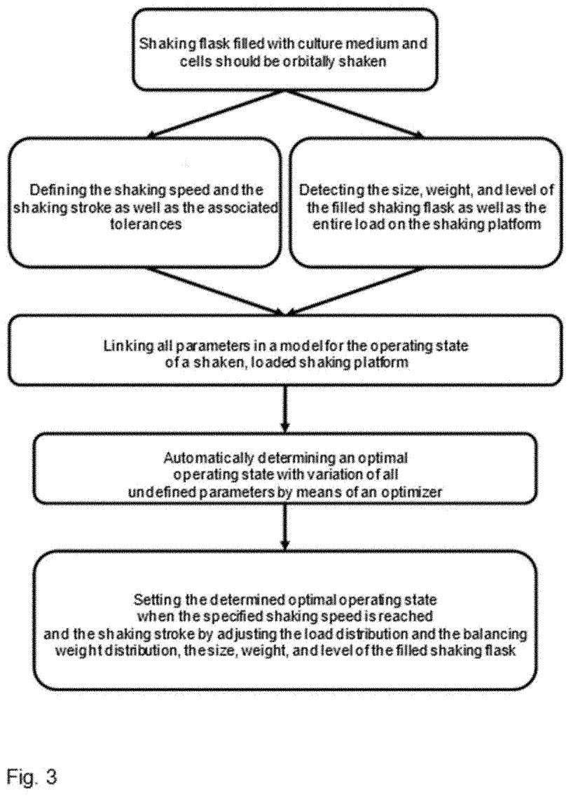

FIG. 3 is a schematic view of an embodiment of the method according to the invention. A shaking flask as shaking vessel 3 is filled with a mixture of culture medium and cells as shaking material 2. Both should be orbitally shaken (shaking movement 4). As target operating parameter 5, the shaking speed and the shaking stroke are set to target values (e.g. 300 rpm, 25 mm) and provided with tolerances (e.g. ±20 rpm, ±0 mm). Another tolerance-free target operating parameter 5 is that the load already mounted on the shaking platform should also continue to be shaken. In addition, a plurality of further operating parameters 6 are detected with regard to their adjustment range that can be used in the context of optimization. The size, weight, and level of the filled shaking flask are detected in connection with the options for adjusting these values from the user's point of view (e.g., use of different flask sizes, materials, adjustment range of the filling volume, etc.). Furthermore, the entire current loading of the shaking platform 14 of the shaking machine 1 is detected, in particular with regard to the positioning of the already assembled shaking vessels 3 and the mass distribution on the shaking platform 14. The adjustment range accessible for optimization is also detected again (for example “how much space is left on the shaking platform 14” and “can the shaking vessels 3 that have already been mounted be repositioned,” etc.). According to the invention, all the parameters collected are linked with their target values, target ranges, tolerances, and adjustment ranges in a model 7 which images the operating state 8 of the shaking machine 1 and in particular the operating state 8 of the shaken, loaded shaking platform 14.

According to the invention, an optimal operating state 8 is now automatically determined by varying all adjustable operating parameters 6 by means of an optimizer 9. The operating parameters 6 causing the optimal operating state 8 found are now set in order to reach or approach the target values of the target operating parameters 5. For this purpose, any necessary adjustments are made according to the optimization results. These can in particular, but not exclusively, be adjustments of the load distribution and the balancing weight distribution, but also adjustments in the choice of the flask size, the flask material, and thus the weight and the filling level of the shaking material 2 in the flask.

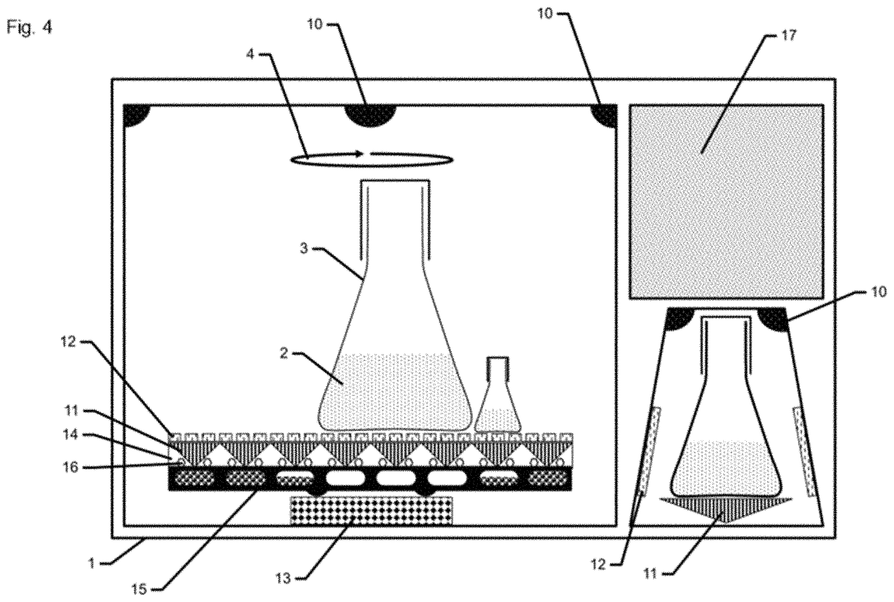

FIG. 4 is a schematic view of a device according to the invention for carrying out the method according to the invention. A shaking machine 1 comprises a shaking drive 13, which subjects a shaking platform 14 and all associated shaking materials 2 and shaking vessels 3 thereof to a shaking movement 4. The shaking machine 1 further comprises an adjustable balancing device 15, which is connected in some embodiments of the invention to the shaking platform 14.

In the shaking platform 14, various sensor arrays (scales 11 and shaking material sensors 12) are integrated, which are suitable for detecting the load distribution of the shaking platform 14 in a spatially resolved manner, in particular, but not exclusively, with regard to the mass distribution, the positioning of shaking vessels 3, the shape and distribution of the shaking materials 2 during the shaking operation, as well as the availability, size, and position of free, as yet unloaded areas of the shaking platform 14.

Furthermore, the device comprises marking devices 16 which, in an advantageous embodiment of the invention, are integrated into the shaking platform 14, for example as LEDs, in order to be able to visualize the adjustments for loading, that are necessary or recommended for the user, in order to achieve an optimal operating state (e.g., by marking the shaking flask positions to be occupied using LED rings that light up, which correspond to the installation surface of the shaking flask).

In some embodiments of the invention, the device according to the invention also comprises at least one camera 10, in particular, but not exclusively, for detecting the load distribution on the shaking platform 14 and for detecting the fill levels and the distribution of the shaking materials 2 in their shaking vessels 3 during the shaking operation. In some embodiments of the invention, a plurality of cameras 10 are used to ensure that the entire shaking platform 14 is monitored or to obtain precise information about the distribution of the shaking materials 2 in their shaking vessels 3 during the shaking operation by means of three-dimensional reconstruction.

In some embodiments, the device according to the invention comprises a region (FIG. 4, bottom right), in order to detect relevant parameters of the shaking vessel 3 and the shaking material 2 to be shaken, even away from the shaking platform 14. Scales 11, cameras 10, or shaking material sensors 12 can also be used in this case.

Furthermore, the device according to the invention comprises a computer having a user interface 17, via which user inputs for target operating parameters 5 and further operating parameters 6 can be made. In addition, the algorithms of the optimizer 9 are executed on the computer 17 and the optimization results and the parameters for achieving the optimal operating state 8 can be visualized here.

In some embodiments of the invention, the balancing device 15 is segmented into many smaller, local balancing weights. In FIG. 4, an embodiment is shown in which many small cavities are arranged below the shaking platform 14, which cavities can be filled or partially filled with a liquid or emptied according to requirements and optimization results, the liquid acting as a moving balancing weight, which, in coordination with the loading of the shaking platform 14, can locally compensate for the unbalance forces and unbalance torques caused by the loading with a comparatively small size and total mass of the device.

### LIST OF REFERENCE SIGNS

For each interpretation of the reference signs, reference shall be made to the description and claims.
1 Shaking machine
2 Shaking material
3 Shaking vessel
4 Shaking movement
5 Target operating parameters
6 Operating parameters
7 Model
8 Operating state
9 Optimizer
10 Camera
11 Scale
12 Shaking material sensor
13 Shaking drive
14 Shaking platform
15 Adjustable balancing device
16 Marking device
17 Computer with user interface

1-11. (canceled)

12. A method for operating a shaking machine, in particular for optimizing an operating state of the shaking machine, the method comprising:
shaking at least one shaking material in at least one shaking vessel;
setting at least one target operating parameter to at least one target value or one target range;
detecting an adjustment range of at least one additional operating parameter;
determining an operating state by means of an optimizer that varies at least one adjustable operating parameter and by using at least one model, such that at least one target operating parameter maintains, achieves, or approaches the target value or target range,
wherein at least one operating state of the shaking machine is imaged by at least one model, wherein the at least one model comprises the at least one adjustable operating parameter and the at least one target parameter and wherein the optimal operating state is determined using the at least one model.

13. The method of claim 12, wherein the at least one operating parameter is adjusted before a start of the shaking process in such a way that the determined optimal operating state is reached or approximated, such that at least one target operating parameter maintains, reaches, or approaches the target value or target range thereof.

14. The method according to claim 12, wherein a position and/or a distribution of shaking materials and/or shaking vessels are detected by suitable sensors.

15. The method according to claim 12, wherein the optimal operating state is achieved by adjusting the position and distribution of the shaking materials or shaking vessels and/or balancing weights of an adjustable balancing device.

16. The method according to claim 12, wherein in order to maintain an optimal operating state, the operating parameters and the target operating parameters are regularly detected and automatically adjusted if necessary.

17. The method according to claim 12, wherein the optimizer, in the event that an optimal operating state cannot be reached, transmits this optimal operating state to the user and submits at least one suggestion for adjusting at least one target operating parameter in order to be able to achieve an alternative operating state of the shaking machine, in particular in order to be able to achieve an optimal operating state of the shaking machine that is as close as possible to the user requirements.

18. A device for performing the method of claim 12, the device comprising:
at least one shaking drive which can drive at least one shaking platform;
at least one shaking vessel which can be subjected to a shaking movement by this shaking platform and which is suitable for receiving a shaking material;
sensors which are set up to detect the position and distribution of the shaking materials and/or the shaking vessels on the shaking platform.

19. The device according to claim 18, further comprising an automatically adjustable balancing device (15).

20. The device according to claim 18, wherein the adjustable balancing device is divided into a plurality of smaller, locally and separately adjustable segments.

21. The device according to claim 18, wherein the shaking platform comprises marking devices which are suitable for visualizing loading recommendations for the user.

22. An arrangement comprising the device according to claim 18 and also a shaking material which is received in the shaking vessel.
